(19) United States
(12) Patent Application Publication
(10) Pub. No.: US 2026/0203029 A1
(43) Pub. Date: Jul. 16, 2026

(54) APPARATUS AND METHOD WITH GENERATION OF COMPUTER PROGRAMMING CODE

(71) Applicant: SAMSUNG ELECTRONICS CO., LTD., Suwon-si (KR)

(72) Inventor: Sungwon JEONG, Suwon-si (KR)

(73) Assignee: SAMSUNG ELECTRONICS CO., LTD., Suwon-si (KR)

(21) Appl. No.: 19/403,641

(22) Filed: Nov. 28, 2025

(30) Foreign Application Priority Data
Jan. 13, 2025 (KR) 10-2025-0004685

(51) Int. Cl. G06F 8/35; G06F 8/70

(52) U.S. Cl. CPC G06F 8/35; G06F 8/70

(57) ABSTRACT

A code provisioning method uses a code provisioning device, and the code provisioning method includes: receiving a code generation request including information on a target task through an interface of the code provisioning device; in response to the receiving of the code generation request, obtaining from a code generation model first code written in the programming language and corresponding to the target task; determining an evaluation score for the first code based on attempting to build the first code; determining whether the evaluation score for the first code is higher than or equal to a threshold score; and determining whether to add the first code to a database based on the evaluation score for the first code and based on an evaluation score for second code with respect to the target task.

### CROSS-REFERENCE TO RELATED APPLICATIONS

This application claims the benefit under 35 USC § 119 (a) of Korean Patent Application No. 10-2025-0004685, filed on Jan. 13, 2025, in the Korean Intellectual Property Office, the entire disclosure of which is incorporated herein by reference for all purposes.

### BACKGROUND

### 1. Field

The following description relates to a code provisioning device and method for providing code written in a programming language.

### 2. Description of Related Art

A machine-learning model trained to generate code may output code generated in a programming language determined according to a user command. A machine-learning model generating code may generate code in a specified or set programming language. The performance of a machine-learning model generating code may be further enhanced through learning using high-quality training data. As the quality of training data used to train the machine-learning model generating code increases, the performance of the machine-learning model generating code may also increase, and an error in code output from the machine-learning model may decrease.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a code provisioning device is configured to provide code in a programming language, and the code provisioning device includes: one or more processors; and a memory storing instructions that when executed by the one or more processors, cause the code provisioning device to: receive a code generation request including information on a target task through an interface of the code provisioning device, in response to the receiving of the code generation request, obtain from a code generation model first code in the programming language and corresponding to the target task, determine an evaluation score for the first code based on attempting to build the first code, determine whether the evaluation score for the first code is higher than or equal to a threshold score, and determine whether to add the first code to a database based on the evaluation score for the first code and based on an evaluation score for second code with respect to the target task.

The instructions, when executed by the one or more processors, may cause the code provisioning device to determine the evaluation score for the first code based on a result of evaluating performance regarding a result of the attempting to build the first code with respect to each of performance evaluation items to evaluate performance of code in the programming language and corresponding to the target task.

The instructions, when executed by the one or more processors, may cause the code provisioning device to determine to add the first code to the database based on the evaluation score for the first code being higher than or equal to a maximum value among evaluation scores for at least one item of second code stored in the database.

The instructions, when executed by the one or more processors, may cause the code provisioning device to determine to provide the second code as a response to the code generation request if the evaluation score for the first code is higher than or equal to the threshold score and the evaluation score for the first code is lower than the evaluation score for the second code.

The instructions, when executed by the one or more processors, may cause the code provisioning device to determine to add the first code to the database based on the evaluation score for the first code being lower than the threshold score and based on an item of code not existing in the database.

The instructions, when executed by the one or more processors, cause the code provisioning device to determine to provide the second code as a response to the code generation request based on the evaluation score for the first code being lower than the threshold score and the second code having an evaluation score higher than or equal to the threshold score.

The instructions, when executed by the one or more processors, may cause the code provisioning device to determine to add the first code to the database, and determine to provide the first code as a response to the code generation request.

The instructions, when executed by the one or more processors, may cause the code provisioning device to determine the evaluation score for the first code after determining to provide the first code obtained from the code generation model as a response to the code generation request.

The instructions, when executed by the one or more processors, may cause the code provisioning device to determine to delete the first code without storing the first code in the database based on the evaluation score for the first code being higher than or equal to the threshold score and based on the evaluation score for the first code being lower than the evaluation score for the second code.

The instructions, when executed by the one or more processors, may cause the code provisioning device to determine to discard the first code without storing the first code in the database based on the evaluation score for the first code being lower than the threshold score and based on the second code having an evaluation score higher than or equal to the threshold score.

In another general aspect, a code provisioning method uses a code provisioning device, and the code provisioning method includes: receiving a code generation request including information on a target task through an interface of the code provisioning device; in response to the receiving of the code generation request, obtaining from a code generation model first code written in the programming language and corresponding to the target task; determining an evaluation score for the first code based on attempting to build the first code; determining whether the evaluation score for the first code is higher than or equal to a threshold score; and determining whether to add the first code to a database based on the evaluation score for the first code and based on an evaluation score for second code with respect to the target task.

The determining of the evaluation score may include: determining the evaluation score for the first code based on a result of evaluating performance regarding a result of the attempting to build the first code with respect to each of performance evaluation items to evaluate performance of code in the programming language and corresponding to the target task.

The determining of whether to add the first code to the database may include: determining to add the first code to the database based on the evaluation score for the first code being higher than or equal to a maximum value among evaluation scores for at least one item of second code stored in the database.

The determining of whether to add the first code to the database may include: determining to provide the second code as a response to the code generation request based on the evaluation score for the first code being higher than or equal to the threshold score and the evaluation score for the first code being lower than the evaluation score for the second code.

The code provisioning method may further include: determining to add the first code to the database based on the evaluation score for the first code being lower than the threshold score and based on an item of second code not existing in the database.

The code provisioning method may further include: determining to provide the second code as a response to the code generation request based on the evaluation score for the first code being lower than the threshold score and the second code having an evaluation score higher than or equal to the threshold score existing in the database.

The code provisioning method may further include: adding the first code to the database; and determining to provide the first code as a response to the code generation request.

The determining of the evaluation score for the first code may include: performing the determining of the evaluation score for the first code after determining to provide the first code obtained from the code generation model as a response to the code generation request.

The code provisioning method may further include: determining to discard the first code without storing the first code in the database based on the evaluation score for the first code being higher than or equal to the threshold score and the evaluation score for the first code is lower than the evaluation score for the second code.

In another general aspect, a method performed by a computing device includes: accessing a database of stored items of second code respectively corresponding code-generation requests; inputting the code-generation requests to a code generation model including a neural network to generate respective items of first code; determining scores of the respective items of first code; for first of the items of first code, storing in the database the first items of first code based on their having scores above a threshold and there being no corresponding item of second code and returning the first items of first code as responses to the corresponding code-generation requests; and for second of the items of first code, based on the second items of first code having scores above the threshold and having respectively corresponding items of second code with higher scores, returning as responses to the corresponding code-generation requests respectively corresponding items of second code.

Other features and aspects will be apparent from the following detailed description, the drawings, and the claims.

### BRIEF DESCRIPTION OF THE DRAWINGS

FIG. 1 illustrates an example of determining whether to add first code obtained from a code generation model to a database, according to one or more embodiments.

FIG. 2 illustrates an example of operations of a code provisioning method according to one or more embodiments.

FIG. 3 illustrates an example of determining whether to add first code to a database based on a comparison between the first code and second code stored in the database, according to one or more embodiments.

FIG. 4 illustrates an example of determining whether to add first code to a database after providing the first code, according to one or more embodiments.

FIG. 5 illustrates an example of a code provisioning device providing code by using a server, according to one or more embodiments.

FIG. 6 illustrates an example of a code provisioning device providing code by using an application, according to one or more embodiments.

FIG. 7 illustrates an example of a configuration of a code provisioning device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

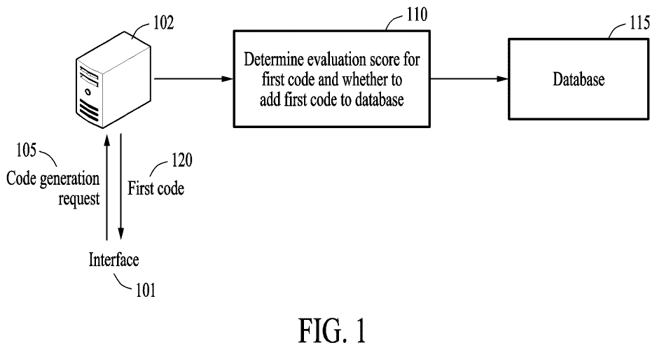

FIG. 1 illustrates an example of determining whether to add first code obtained from a code generation model to a database, according to one or more embodiments.

Referring to FIG. 1, a code provisioning device (e.g., a code provisioning device 700 of FIG. 7) is a computing device providing code obtained from a code generation model 102 in response to a code generation request 105. The code generation request 105 may be a request for the code provisioning device to generate code for performing a specific task. The code obtained from the code generation model 102 is generally compliant with the syntactic and lexical rules, and others, of a specific programming language, and, when the code is executed. Generally, the code is source code, and the code may be executed by an interpreter or by executing instructions compiled/translated from the code. Upon execution of the code, a task included/specified in the code generation request 105 may be performed. The code generation model 102 is described below.

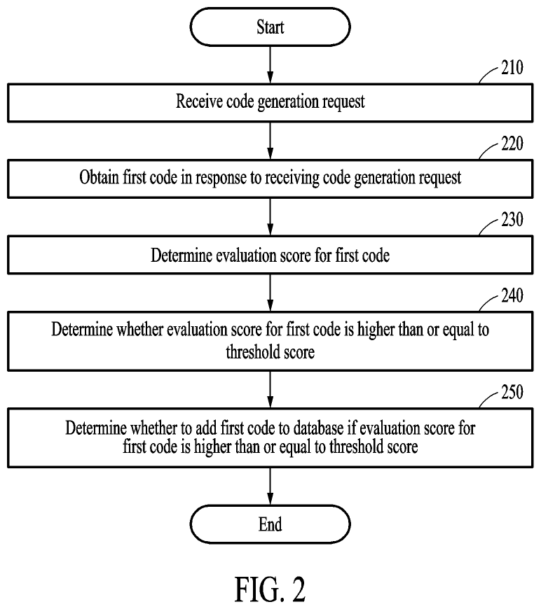

The code provisioning device may build the code generated by the code generation model 102 based on a predefined build template environment in a server, e.g., a server including the code generation model 102 or a server (or an electronic device) providing a code generation service. The code provisioning device may determine evaluation scores for defined evaluation items by using the result of the build. The defined evaluation items are described with reference to FIG. 2. A build may involve the conversion (or encoding) of code (e.g., source code) written in a programming language into a binary file (or a non-text file, e.g., processor instructions) that may be used (or executed) by a computer. The build may include a compiling process that converts the source code into a machine language and a linking process that generates an executable execution file through a combination of an object file and a library prepared in a build template.

The code provisioning device may determine whether to add code outputted from the code generation model 102 to a database 115, and may make that decision based on the determined evaluation scores. For example, when the code provisioning device receives the code generation request 105, the code provisioning device may obtain first code 120 written in a programming language corresponding to a target task (which is specified in the code generation request 105) from the code generation model 102. The target task refers to a task required to achieve a main objective. For example, if a code generation request is “Generate computer programming code detecting a bicycle in an input image”, the target task may be “Detect a bicycle in the image”. The code provisioning device may determine an evaluation score for the first code 120. The code provisioning device may add the first code 120 to the database 115 if the evaluation score for the first code 120 is higher after comparing the evaluation score for the first code 120 with an evaluation score for second code stored in the database 115. Generally, herein, “second code” refers to code that is stored in a database and that is related to the target task.

The code provisioning device may improve the performance of the code generation model 102 by performing fine-tuning training on the code generation model 102 by using the code stored in the database 115. The database 115 may store a collection of data and may include logic for managing the storing of the data. The database 115 may be located inside or outside the code provisioning device. Generally speaking, fine-tuning training may involve additional training of an already-trained machine-learning model (e.g., a neural network) by using training data prepared for a specific task. The code provisioning device may generate source code with fewer errors by using the fine-tuned code generation model 102. The code provisioning device may perform fine-tuning training on the code generation model 102 by using the first code 120 stored in the database 115 during an idle time of the code provisioning device, for example. The idle time may be any time during which the code provisioning device is operational but is in a standby state without processing any actual work (e.g., not generating code). A determination of whether to add the first code 120 to the database 115 based on the code provisioning device comparing the first code 120 with the second code is described below.

In an embodiment, the code provisioning device may receive the code generation request 105 through an interface 101. The interface 101 refers to a boundary where different devices or systems may interact with one another. The code generation request 105 may include information about the target task. For example, the code provisioning device may receive the code generation request 105 from a touch/input panel of a mobile terminal, “Generate code detecting a car included in an input image”. In brief, the code generation request 105 may include a text description (or prompt) of the need for code and the task that the needed code is to perform.

Based on the code generation request 105, the code provisioning device may obtain/generate code (e.g., first code) from the code generation model 102. The code provisioning device may obtain the first code 120 conformant to the programming language and configured to perform the target task from the code generation model 102 in response to receiving the code generation request 105.

The code generation model 102 is a machine-learning model configured to output/generate code conformant to the requirements (e.g., lexical, grammatical, semantic, etc.) of a programming language and to do so based on the content of code generation request 105 (e.g., the code generation request 105 that is input from a user through the interface 101). The code generation model 102 may output code expressed in a specified or set programming language. The code generation model 102 is a machine-learning model that may be based on a transformer architecture and that may include neural network layers such as an input layer, an encoder layer, a decoder layer, and an output layer. Each layer may consist of weights of connections to another layer (usually adjacent, but not necessarily), and the weights may be adjusted by training of the code generation model 102. Processes performed by the layers may be similar to the processes performed by natural language processing models.

The input layer of the code generation model 102 may tokenize input data (e.g., the code generation request 105). For example, the input layer may tokenize the input data by using the Byte-Pair Encoding (BPE) algorithm or the WordPiece algorithm. The input layer may output a vector that transforms the tokenized input data.

The structure of the encoder layer of the code generation model 102 may be based on the structure of a transformer encoder. The encoder layer may include a self-attention neural network/layer or a feedforward neural network/layer. The encoder may output a vector that is obtained by adding to the vector a relationship (e.g., contextual information) of the input data as obtained from the input data.

The structure of the decoder layer of the code generation model 102 may be based on the structure of a transformer decoder. The decoder layer may predict the next token by using result values output by the encoder. For example, the decoder layer may predict the next token by using the input data and the vector (to which the relationship of the input data has been added).

The output layer of the code generation model 102 may calculate a probability distribution for predicted tokens. For example, the output layer may calculate the probability distribution for the predicted tokens by using the SoftMax function. The output layer may select a token with the highest probability from the calculated probability distribution and may output text data (e.g., code corresponding to the code generation request 105) by using tokens selected in this manner.

The code generation model 102 may be trained through a supervised or unsupervised learning method. The process of training the code generation model 102 may include, for example, the process of preprocessing training data, obtaining predicted code from the code generation model 102 by using the preprocessed training data, and updating parameters of the code generation model 102 by using the predicted code.

The training data used by the code generation model 102 may include the training code generation request 105 and training code data and may further include label data if using supervised learning.

The preprocessing of the training data may include a tokenization process for dividing the input training code data into token units, an annotation process for the training code data to train the contextual information of the training code data, a syntax tree generation process for the training code data to train the structural information of the training code data, and a normalization process for the data.

The obtaining of the predicted code from the code generation model 102 may involve obtaining a predicted code corresponding to the training code generation request 105 by encoding and decoding the preprocessed training code data. The encoding and decoding of the preprocessed training code data may be performed by an encoder and decoder that with structure that may be based on a transformer model.

The optimizing of the code generation model 102 may include determining a loss (or a loss function) for a predicted value output from the code generation model 102 and minimizing the determined loss. The process of minimizing the determined loss may include differentiating the loss function to determine how much each parameter of the code generation model 102 contributes to the loss and updating the parameters according to the degree of contribution. The updating of the parameters may use gradient descent or a technique modified from the gradient descent. The code generation model 102 may learn a pattern from the training code data through this training process and may have the ability to output (or predict) code corresponding to a new code generation request 105.

The code provisioning device may perform operation 110 of determining the evaluation score for the first code 120 and whether to add the first code 120 to the database 115. For example, the code provisioning device may determine the evaluation score for the first code 120 based on the build (mentioned above) of the first code 120. The evaluation score refers to a numerical value that indicates the performance of the code written in a programming language corresponding to the target task. The determining of the evaluation score for the first code 120 based on the result of the build is described with reference to FIG. 2.

The code provisioning device may determine whether to add the first code 120 to the database 115 by comparing the evaluation score for the first code 120 with the evaluation score for the second code, which is already stored in the database 115. For example, the code provisioning device may store code having a higher score in the database 115 by comparing the evaluation score for the first code 120 with the evaluation score for the second code and may provide the code to the user through the interface 101. The code provisioning device may add the first code 120 to the database 115 if the evaluation score for the first code 120 is higher than (or equal to) the evaluation score for the second code and may discard the first code 120 without adding the first code 120 to the database 115 if the evaluation score for the first code 120 is lower than the evaluation score for the second code.

If the first code 120 is added to the database 115, the added first code 120 may be used for the fine-tuning training of the code generation model 102 of the code provisioning device. For example, if the first code 120 is added to the database 115, the added first code 120 may be used for the fine-tuning training of the code generation model 102 during idle time, which is time when the code provisioning device is not in use. The code provisioning device, when trained with code in the database, may provide the user with code with fewer errors and higher performance by providing a piece of code with a higher evaluation score among evaluation scores for pieces of code.

FIG. 2 illustrates an example of operations of a code provisioning method according to one or more embodiments. The operations of the code provisioning method may be performed by a code provisioning device (e.g., the code provisioning device of FIG. 1 or the code provisioning device 700 of FIG. 7).

In operation 210, the code provisioning device may receive a code generation request (e.g., the code generation request 105 of FIG. 1). The code provisioning device may receive the code generation request (which includes information on a target task) through an interface (e.g., the interface 101 of FIG. 1). For example, the code provisioning device may receive the code generation request from a user interface (e.g., a graphical user interface, a command interface, a voice user interface, etc.) or a software interface (e.g., an application interface, an application programming interface to a network service, a database interface, etc.), but examples are not limited thereto.

In operation 220, the code provisioning device may obtain/generate/infer first code (e.g., the first code 120 of FIG. 1) in response to receiving the code generation request. For example, the code provisioning device may obtain the first code written in a programming language corresponding to the target task (e.g., the information on the target task may also specify a target programming language) from a code generation model (e.g., the code generation model 102 of FIG. 1) in response to receiving the code generation request. An example of the code provisioning device obtaining the first code from the code generation model is described with reference to FIG. 1.

In operation 230, the code provisioning device may determine an evaluation score for the first code. The evaluation score may be a numerical value that indicates the performance of the code when the code is executed. The code provisioning device may determine the evaluation score for the first code based on a build of the first code. When the code is attempted to be built, the result of the build attempt may include, for example, a build success message, a build error message, a warning message, debugging information, and a log file path. A build success message may indicate that the build is completed successfully as the result of building the code. A build error message may indicate that a problem occurred during the build. A warning message may indicate that the building is successful, but a relatively minor problem occurs (e.g., compile feedback). Debugging information may be a warning for debugging or information related to optimization. A log file path be a location of a file containing detailed information on the build process. A build error message may include a compiling error that occurs where there is an error in code syntax, a linking error that occurs where there is a problem with a referred library, a resource shortage that occurs where memory is insufficient, an environment setting problem that occurs where a path is incorrect, or the like.

The code provisioning device may determine, for each of performance evaluation items, an evaluation score for the first code based on the result of evaluating the result of attempting to build the first code. The performance evaluation items may be defined to evaluate the performance of the code. For example, the code provisioning device may determine an evaluation score for the first code based on evaluating performance regarding the result of building the first code with respect to each of the performance evaluation items for evaluating the performance of the code. The performance evaluation items may include a build success message, a build error message, a warning message, debugging information, and a log file path, which appear when the code is built, but examples are not limited thereto. For example, the code provisioning device may determine an evaluation score for each of the performance evaluation items included in Table 1 below.

TABLE 1

| | | | Critical | | |
|---|---|---|---|---|---|
| Build | | Empty | section | Execution | |
| error | Warning | size | size | speed | Total |
| 70 | 1 | 7 | 7 | 15 | 100 |

In the example shown in Table 1, the performance evaluation items include a build error, a warning, an empty size, a critical section size, and an execution speed. The code provisioning device may determine a relative evaluation score for each item based on the total evaluation score of 100. The empty size refers to the size of a gap used in the process of dividing the code obtained from the code generation model into specific intervals. The critical section size refers to the size or proportion of a code portion used to perform the target task in the code obtained from the code generation model. Together, the empty size and critical section size may indicate a kind of efficiency of the code. The execution speed refers to a speed at which the code is executed when the code obtained from the code generation model is executed.

In operation 240, the code provisioning device may determine whether the evaluation score for the first code is higher than or equal to a threshold score. The evaluation score for the first code refers to a sum of evaluation scores of respective evaluation items for the first code. The threshold score refers to a score that serves as a reference for determining whether the first code obtained from the code generation model may be used to perform a task.

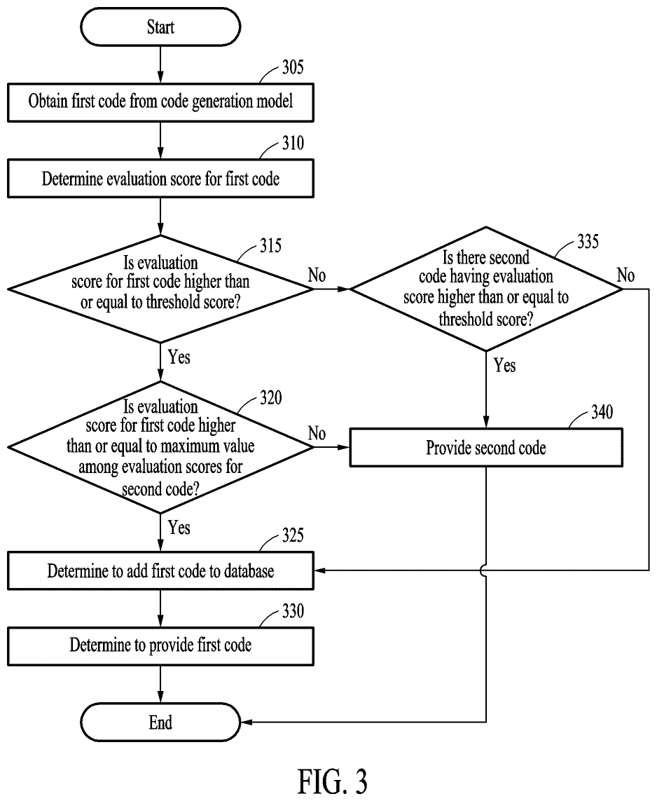

The code provisioning device may determine, for example, whether the evaluation score for the first code is higher than or equal to the threshold score (e.g., 75 points). The threshold score may be defined varyingly depending on the intended use of the code output from the code generation model and is not limited to the forgoing example. The code provisioning device determining whether the evaluation score for the first code is higher than or equal to the threshold score is described with reference to FIG. 3.

In operation 250, the code provisioning device may determine whether to add the first code to a database if the evaluation score for the first code is higher than or equal to the threshold score. The code provisioning device may determine whether to add the first code to the database based on the evaluation score for the first code and an evaluation score for second code if the evaluation score for the first code is higher than or equal to the threshold score. For example, if the sum of the evaluation scores of respective evaluation items for the first code is higher than or equal to the threshold score (e.g., 75 points) (e.g., if the sum of the evaluation scores of respective evaluation items for the first code is 86 points), the code provisioning device may determine whether to add the first code to the database based on the evaluation score for the first code and the evaluation score for the second code related to the target task stored in the database. The second code may be related to the target task and is already stored in the database. The code provisioning device may add the first code to the database, discard the first code without adding the first code to the database, or provide the second code if the evaluation score for the first code is higher than or equal to the threshold score. In an embodiment, the code provisioning device may provide the second code to the user without determining to add the first code to the database if the sum of the evaluation scores for the first code is lower than the threshold score (e.g., 75 points) (e.g., if the sum of the evaluation scores of respective items for the first code is 71 points).

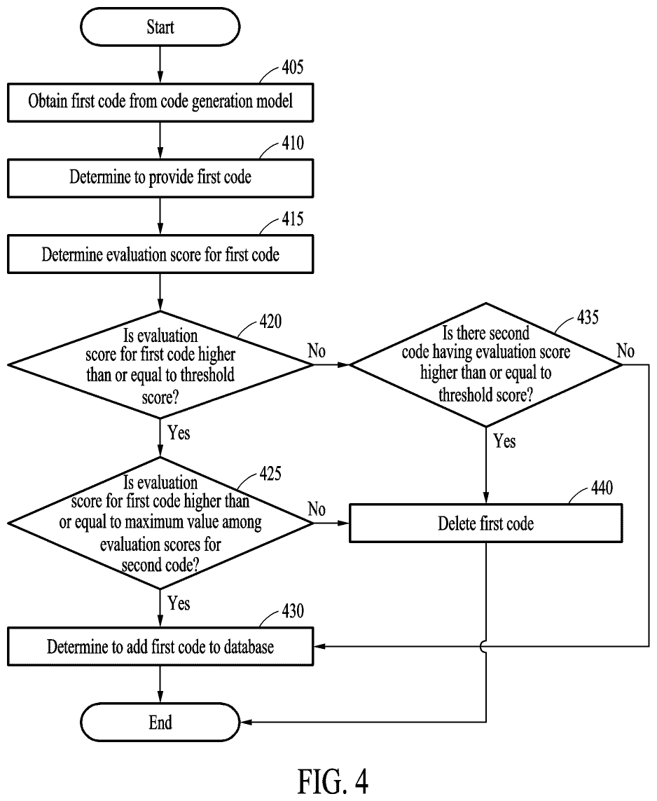

The code provisioning device determining whether the first code is higher than or equal to the threshold score and determining whether to add the first code to the database based on comparing the first code with the second code is described with reference to FIGS. 3 and 4.

FIG. 3 illustrates an example of determining whether to add first code to a database based on a comparison between the first code and second code stored in the database, according to one or more embodiments.

In operation 305, a code provisioning device (e.g., the code provisioning device 700 of FIG. 7) may obtain the first code from a code generation model. The code provisioning device may input a code generation request received through an interface (e.g., the interface 101) into the code generation model and may obtain the first code from the code generation model. The code provisioning device obtaining the first code from the code generation model is described with reference to FIG. 1.

In operation 310, the code provisioning device may determine an evaluation score for the first code. The code provisioning device may determine the evaluation score for the first code based on evaluating performance regarding the result of attempting to build the first code with respect to each of the performance evaluation items for evaluating the performance of the code written in a programming language. For example, the code provisioning device may determine the evaluation score by adding the following sub-scores, as applicable: a build error, 70 points; a warning, 1 point; an empty size, 7 points; a critical section size, 7 points; and an execution speed, 15 points. These sub-scores may be determined based on the evaluation items included in Table 1 as shown above for the result of the attempting to build the first code. The code provisioning device determining an evaluation score is described in detail in operation 230 of FIG. 2.

In operation 315, the code provisioning device may determine whether the evaluation score for the first code is higher than or equal to a threshold score. The threshold score may be defined varyingly depending on the intended use of the code output from the code generation model. For example, if the first code output from the code generation model is code for security use, the threshold score may be a relatively high score (e.g., 99 points). In this case, the code provisioning device may determine whether the evaluation score for the first code is 99 points or higher. If the first code output from the code generation model is code for an arithmetic operation, the threshold score may be a relatively low score (e.g., 70 points). In this case, the code provisioning device may determine whether the evaluation score for the first code is 70 points or higher.

In operation 320, the code provisioning device may determine whether the evaluation score for the first code is higher than or equal to a maximum value among evaluation scores for corresponding items of second code if the evaluation score for the first code is higher than or equal to the threshold score (e.g., “Yes” in operation 315). The second code may be mapped to the database with a data query for the second code and the evaluation scores for the second code. The data query refers to a command to search the database to retrieve the second code from the database in response to the code generation request. The code provisioning device may determine whether the evaluation score for the first code is higher than or equal to the maximum value (e.g., 89 points) among the evaluation scores (e.g., 83 points, 85 points, and 89 points) for the second code retrieved from the database. To summarize, the item(s) of second code may be linked to the first code via a same (or semantically similar/equivalent) data query, and the item(s) of second code may be in a database (or any data store) associated with the data query, or, the item(s) of second code may be in a larger database/table in which items of second code are associated with respective data queries. Thus, given a data query (e.g., in a code generation request), item(s) of second code corresponding to a code generation request may be obtained from the database.

If the evaluation score for the first code is higher than or equal to the threshold score, and the evaluation score for the first code is higher than or equal to the maximum value of the evaluation scores for the item(s) of second code (e.g., “Yes” in operation 315 and “Yes” in operation 320), the code provisioning device may determine to add the first code to the database in operation 325. For example, the evaluation score for the first code may be 95 points, which is higher than or equal to the threshold score (e.g., 75 points). The evaluation scores for the items of second code stored in the database may be 83 points, 85 points, and 89 points. The maximum value of the example evaluation scores for the items of second code is 89 points. In this case, the code provisioning device may determine to add the first code to the database because the evaluation score for the first code (e.g., 95 points) is higher than or equal to the maximum value (e.g., 89 points) of the evaluation scores for the second code.

If the evaluation score for the first code is higher than or equal to the threshold score, and the evaluation score for the first code is lower than the evaluation scores for the second code (e.g., “Yes” in operation 315 and “No” in operation 320), the code provisioning device may determine to provide an item of the second code in response to the code generation request in operation 340. For example, the evaluation score for the first code may be 87 points, which is higher than or equal to the threshold score (e.g., 75 points), and the maximum value of the evaluation scores for the second code may be 89 points. In this case, the code provisioning device may determine to not add the first code to the database because the evaluation score for the first code (e.g., 87 points) is lower than the maximum value (e.g., 89 points) of the evaluation scores for the items of second code and may provide the item of second code of with the maximum evaluation score (e.g., 89 points) through the interface.

If the evaluation score for the first code is lower than the threshold score (e.g., “No” in operation 315), the code provisioning device may determine whether there is an item of second code having an evaluation score higher than or equal to the threshold score in operation 335. For example, if the evaluation score for the first code is 73 points and the threshold score is 75 points, the code provisioning device may determine whether the database includes the second code having 75 points or higher in the database.

If the evaluation score for the first code is lower than the threshold score and the database does not include a corresponding item of second code (“No” in operation 315 and “No” in operation 335), the code provisioning device may determine to add the first code to the database in operation 325. For example, the evaluation score for the first code may be 73 points, which is lower than the threshold score (e.g., 75 points). The database may not include an item of second code having a score higher than the threshold score (e.g., 75 points), and, in this case, the code provisioning device may add the first code to the database.

If the evaluation score for the first code is lower than the threshold score and the database includes an item of second code having an evaluation score higher than or equal to the threshold score (“No” in operation 315 and “Yes” in operation 335), the code provisioning device may determine to provide the item of second code in operation 340. For example, the evaluation score for the first code may be 73 points, which is lower than the threshold score (e.g., 75 points). The evaluation scores for the items of second code stored in the database may be 76 points, 77 points, and 89 points. In this case, the code provisioning device may provide the second code having the evaluation score of 89 points through the interface without adding the first code to the database.

In operation 330, the code provisioning device may determine to provide the first code. The code provisioning device may determine to provide the first code through the interface (e.g., a graphical user interface or an application programming interface). For example, the code provisioning device may determine to provide the first code through the graphical user interface (e.g., a screen of a mobile terminal).

The code provisioning device may provide code with higher performance and fewer errors by providing the first code exhibiting better performance if the evaluation score for the first code obtained from the code generation model is higher than or equal to the evaluation scores for the second code stored in the database and providing the second code if the evaluation score for the first code is lower than the evaluation scores for the second code stored in the database.

The process of adding the first code to the database if the evaluation score for the first code is higher by comparing the evaluation score for the first code with the evaluation scores for the second code may enable the addition (or collection) of code with better performance to the database. Items of data in the database constructed through such a collection process may be used for the fine-tuning training of the code generation model of the code provisioning device. For example, the fine-tuning training may be performed on the code generation model by using the items of data in the database during idle time of the code provisioning device.

The code provisioning device may be used where both a programming language using an interpreter approach and a programming language not using an interpreter approach are used. The programming language using an interpreter approach refers to a programming language that reads source code line-by-line and processes a command during the execution of code. That is, “interpreter” is used in the ordinary meaning. The programming language not using an interpreter approach refers to a programming language that goes through a compiling process for the execution of code. The code provisioning device may determine an evaluation score for the result of building the whole code by executing the first code line-by-line without dividing the first code obtained from the code generation model into code blocks during the execution of code. Accordingly, the code provisioning device may be used regardless of whether the programming language uses an interpreter or a compiler.

FIG. 4 illustrates an example of determining whether to add first code to a database after providing the first code, according to one or more embodiments.

FIG. 3 is an example of providing the first code (e.g., the first code 120 of FIG. 1) after determining whether to add the first code obtained from a code generation model (e.g., the code generation model 102 of FIG. 1) by a code provisioning device (e.g., the code provisioning device 700 of FIG. 7) to a database (e.g., the database 115 of FIG. 1), whereas FIG. 4 is an example of determining whether to add the first code to the database after providing a user with the first code obtained from the code generation model first. The code provisioning device may reduce a response time to a code generation request (e.g., the code generation request 105 of FIG. 1) by determining whether to add the first code to the database after providing the user with the first code obtained from the code generation model first.

In operation 405, the code provisioning device may obtain the first code from the code generation model. The code provisioning device may input the code generation request received through an interface (e.g., the interface 101 of FIG. 1) into the code generation model and may obtain the first code from the code generation model. The code provisioning device obtaining the first code from the code generation model corresponds to operation 305 of FIG. 3, and any repeated description thereof is omitted.

In operation 410, the code provisioning device may determine to provide the first code. For example, the code provisioning device may determine to provide the first code first without comparing an evaluation score for the first code with an evaluation score for second code stored in the database. The code provisioning device may reduce the user-responsiveness of the code generation request by providing the first code first.

In operation 415, the code provisioning device may determine the evaluation score for the first code. For example, the code provisioning device may determine the evaluation score for the first code after determining to provide the first code obtained from the code generation model as a response to the code generation request.

In operation 425, the code provisioning device may determine whether the evaluation score for the first code is higher than or equal to a threshold score. The threshold score may be defined varyingly depending on the intended use of the code output from the code generation model. The code provisioning device may determine whether the evaluation score for the first code is higher than or equal to the threshold score (e.g., the threshold score of 99 points where the first code is code for security use) defined varyingly depending on the intended use of the code. The code provisioning device determining whether the evaluation score for the first code is higher than or equal to the threshold score corresponds to operation 315 of FIG. 3.

In operation 425, the code provisioning device may determine whether the evaluation score for the first code is higher than or equal to a maximum value among evaluation scores for item(s) of second code if the evaluation score for the first code is higher than or equal to the threshold score (e.g., “Yes” in operation 420). For example, the code provisioning device may determine whether the evaluation score for the first code is higher than or equal to the maximum value (e.g., 87 points) among the evaluation scores (e.g., 81 points, 83 points, and 87 points) for the second code retrieved from the database. The code provisioning device determining whether the evaluation score for the first code is higher than or equal to the maximum value among evaluation scores for the second code corresponds to operation 320 of FIG. 3, and thus, any repeated description thereof is omitted.

If the evaluation score for the first code is higher than or equal to the threshold score, and the evaluation score for the first code is higher than or equal to the maximum value of the evaluation scores for the second code (e.g., “Yes” in operation 420 and “Yes” in operation 425), the code provisioning device may determine to add the first code to the database in operation 430. For example, the evaluation score for the first code would be 95 points, which is higher than or equal to the threshold score (e.g., 75 points). The evaluation scores for the second code stored in the database may be 83 points, 85 points, and 89 points, and the maximum value of the evaluation scores for the second code would be 89 points. In this case, the code provisioning device may determine to add the first code to the database because the evaluation score for the first code (e.g., 95 points) is higher than or equal to the maximum value (e.g., 89 points) of the evaluation scores for the second code.

If the evaluation score for the first code is higher than or equal to the threshold score, and the evaluation score for the first code is lower than the evaluation scores for the second code (e.g., “Yes” in operation 420 and “No” in operation 425), the code provisioning device may delete the first code in operation 440. For example, the evaluation score for the first code may be 87 points, which is higher than or equal to the threshold score (e.g., 75 points). The evaluation scores for the second code stored in the database may be 83 points, 85 points, and 89 points, and the maximum value of the evaluation scores for the second code may be 89 points. In this case, the code provisioning device may discard the first code without adding the first code to the database.

If the evaluation score for the first code is lower than the threshold score (e.g., “No” in operation 420), the code provisioning device may determine whether there is an item of second code having an evaluation score higher than or equal to the threshold score in operation 435. For example, if the evaluation score for the first code is 73 points and the threshold score is 75 points, the code provisioning device may determine whether the database includes an item of second code having a score higher than or equal to 75 points in the database.

If the evaluation score for the first code is lower than the threshold score and the database does not include the second code (“No” in operation 420 and “No” in operation 435), the code provisioning device may determine to add the first code to the database in operation 430. For example, the evaluation score for the first code may be 73 points, which is lower than the threshold score (e.g., 75 points). The database may not include the second code having a score higher than the threshold score (e.g., 75 points). In this case, the code provisioning device may determine to add the first code to the database.

If the evaluation score for the first code is lower than the threshold score and there is the second code having an evaluation score higher than or equal to the threshold score (“No” in operation 420 and “Yes” in operation 435), the code provisioning device may delete the first code as a response to the code generation request in operation 440. For example, the evaluation score for the first code may be 73 points, which is lower than the threshold score (e.g., 75 points). The evaluation scores for the second code stored in the database may be 76 points, 77 points, and 89 points. In this case, the code provisioning device may delete the first code without adding the first code to the database.

The code provisioning device may reduce the response time to the code generation request by determining whether to add the first code to the database after determining to provide the first code obtained from the code generation model. The process of the code provisioning device adding the first code to the database if the evaluation score for the first code is higher by comparing the evaluation score for the first code with the evaluation scores for the second code after providing the first code may enable the addition (or collection) of code with better performance to the database. Items of code in the database constructed through such a collection process may be used for the fine-tuning training of the code generation model of the code provisioning device.

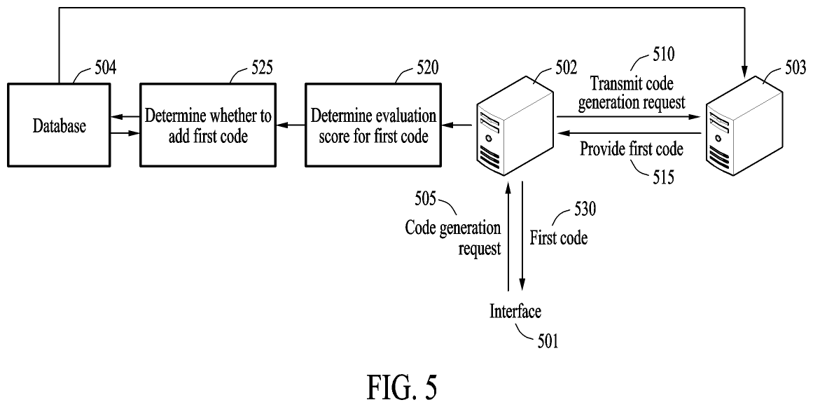

FIG. 5 illustrates an example of a code provisioning device providing code by using a server, according to one or more embodiments.

Referring to FIG. 5, the code provisioning device (e.g., the code provisioning device 700 of FIG. 7) may cause a server 502 to receive a code generation request 505 through an interface 501 and to perform operation 510 of transmitting (or inputting) the received code generation request 505 to a code generation model 503.

The server 502 may be a computer device or a computer system providing information (or data) or services over a network. The server 502 may include a processor, a memory, and a separate storage to perform a requested task. The server 502 may include an application server 502 processing necessary data in response to a client's request or a computing server 502 performing a large-scale calculation or analysis task on behalf of the client.

The code generation model 503 may perform operation 515 of providing first code 530 to the server 502 in response to the transmitted code generation request 505. The code provisioning device may cause the server 502 to perform an operation of providing the first code 530 through the interface 501 after performing operation 520 of determining an evaluation score for the first code 530. Alternatively, the code provisioning device may cause the server 502 to perform operation 520 of determining the evaluation score for the first code 530 after determining to provide the first code 530 obtained from the code generation model 503 as a response to the code generation request 505. The code provisioning device may cause the server 502 to perform operation 525 of determining whether to add the first code 530 to a database 504. For example, the code provisioning device may cause the server 502 to perform an operation of determining whether to add the first code 530 to the database 504 by comparing the evaluation score for the first code 530 with the evaluation score for the second code stored in the database 504 if the evaluation score for the first code 530 is higher than or equal to a threshold score. Operation 525 of determining whether to add the first code 530 to the database 504 is described with reference to FIGS. 3 and 4.

The process of adding the first code 530 to the database 504 if the evaluation score for the first code 530 is higher by comparing the evaluation score for the first code 530 with the evaluation scores for the second code may enable the addition (or collection) of code with better performance to the database 504. Pieces of data in the database 504 constructed through such a collection process may be used for the fine-tuning training of the code generation model 503.

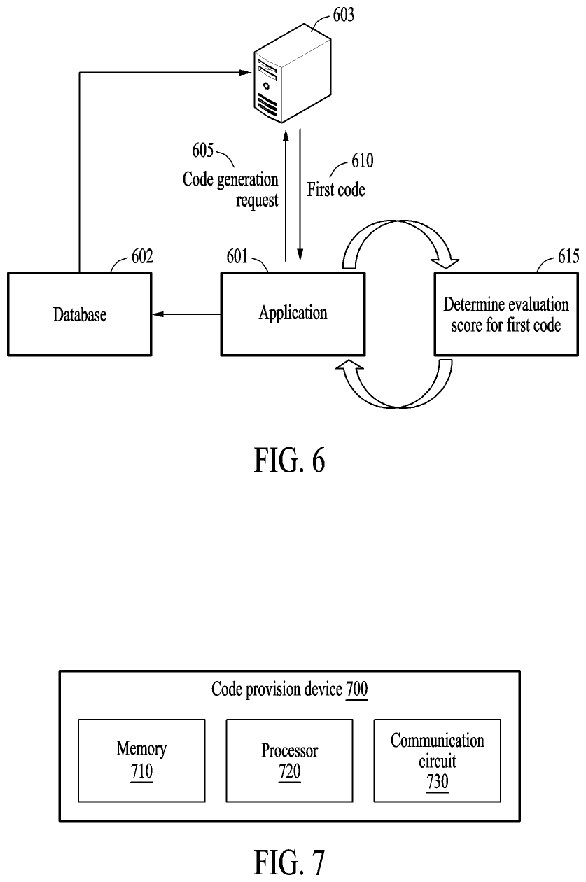

FIG. 6 illustrates an example of a code provisioning device providing code by using an application, according to one or more embodiments.

Referring to FIG. 6, the code provisioning device (e.g., the code provisioning device 700 of FIG. 7) may cause an application 601 to input (or transmit) a code generation request 605 to a code generation model 603 and to obtain first code 610 from the code generation model 603. The application 601 refers to a software program for performing a specific task. For example, the application 601 may be a software program that transmits the code generation request 605 requesting the generation of code to perform a target task and determines whether to add the code received in response to the code generation request 605 to a database 602.

The code provisioning device may perform operation 615 of determining an evaluation score for the first code based on the result of evaluating performance regarding the result of building the first code 610 for each of performance evaluation items. For example, a performance evaluation item may include a build error, a warning, a bean size, a critical section size, and an execution speed, and the code provisioning device may determine a relative evaluation score to the build error, the warning, the bean size, the critical section size, and the execution speed. Operation 615 of determining an evaluation score for the first code 610 is described in detail in operation 230 of FIG. 2, and any repeated description thereof is omitted. The code provisioning device may cause the application 601 to perform an operation of determining whether to add the first code 610 to the database 602. For example, the code provisioning device may cause the application 601 to perform an operation of determining whether to add the first code 610 to the database 602 by comparing the evaluation score for the first code 610 with the evaluation score for the second code stored in the database 602 if the evaluation score for the first code 610 is higher than or equal to a threshold score. The determining of whether to add the first code 610 to the database 602 is described with reference to FIGS. 3 and 4.

The process of adding the first code 610 to the database 602 if the evaluation score for the first code 610 is higher by comparing the evaluation score for the first code 610 with the evaluation scores for the second code may enable the addition (or collection) of code with better performance to the database 602. Items of data/code in the database 602 constructed through such a collection process may be used for the fine-tuning training of the code generation model 603.

FIG. 7 illustrates an example of a configuration of a code provisioning device according to one or more embodiments.

Referring to FIG. 7, the code provisioning device 700 may include a memory, a processor 720, and a communication circuit 730. The code provisioning device 700 may correspond to the code provisioning device described in the present disclosure.

The memory 710 may store instructions executable by the processor 720. When executed by the processor 720, the instructions executable by the processor 720 may cause the processor 720 to perform a code provisioning method. The memory 710 may be integrated with the processor 720. For example, random-access memory (RAM) or flash memory may be integrated with the processor 720 like an integrated circuit microprocessor. The memory 710 may include a separate device, such as a storage device that may be used by an external disk drive, a storage array, or a database system. The memory 710 and the processor 720 may be operatively integrated or may communicate with each other via an input/output (I/O) port, a network connection, or the like so that the processor 720 may read a file stored in the memory 710. The memory 710 may be a non-transitory computer-readable storage medium that stores instructions. When executed by the processor 720, the instructions stored in the memory 710 may prompt at least one processor 720 to cause the code provisioning device 700 to perform the code provisioning method.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and other devices.

The communication circuit 730 may communicate using a direct (e.g., wired) communication channel or a wireless communication channel between the code provisioning device 700 and an external electronic device (e.g., a user terminal device). The communication circuit 730 may include one or more communication processors that operate independently of the processor 720 and support direct (e.g., wired) or wireless communication. The communication circuit 730 may be implemented as a single chip or as a plurality of chips. The communication circuit 730 may receive a code generation request. For example, the communication circuit 730 may receive the code generation request from a mobile terminal (e.g., a smartphone).

The processor 720 may execute instructions stored in the memory 710. The processor 720 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof. When the instructions are executed by the processor 720, the processor 720 may control the code provisioning device 700 to perform operations of the code provisioning method described in the present disclosure.

In an embodiment, the code provisioning device 700 providing code written in a programming language through an interface of the code provisioning device 700 may receive a code generation request including information on a target task through an interface of the code provisioning device, may obtain first code written in a programming language corresponding to the target task from a code generation model, in response to the receiving of the code generation request, may determine an evaluation score for the first code based on building the first code, may determine whether the evaluation score for the first code is higher than or equal to a threshold score, and may determine whether to add the first code to a database based on the evaluation score for the first code and an evaluation score for second code related to the target task stored in the database if the evaluation score for the first code is higher than or equal to the threshold score.

The code provisioning device 700 may determine the evaluation score for the first code based on the result of evaluating performance regarding a result of the building of the first code with respect to each of performance evaluation items to evaluate performance of code written in the programming language corresponding to the target task.

The code provisioning device 700 may determine to add the first code to the database if the evaluation score for the first code is higher than or equal to a maximum value among evaluation scores for at least one piece of second code stored in the database.

The code provisioning device 700 may determine to provide the second code as a response to the code generation request if the evaluation score for the first code is higher than or equal to the threshold score and the evaluation score for the first code is lower than the evaluation score for the second code.

The code provisioning device 700 may determine to add the first code to the database if the evaluation score for the first code is lower than the threshold score and the second code does not exist in the database.

The code provisioning device 700 may determine to provide the second code as a response to the code generation request if the evaluation score for the first code is lower than the threshold score and the second code having an evaluation score higher than or equal to the threshold score exists in the database.

The code provisioning device 700 may determine to add the first code to the database and may determine to provide the first code as a response to the code generation request.

The code provisioning device 700 may perform the determining of the evaluation score for the first code after determining to provide the first code obtained from the code generation model as a response to the code generation request.

The code provisioning device 700 may determine to delete the first code without storing the first code in the database if the evaluation score for the first code is higher than or equal to the threshold score and the evaluation score for the first code is lower than the evaluation score for the second code.

The code provisioning device 700 may determine to delete the first code without storing the first code in the database if the evaluation score for the first code is lower than the threshold score and the second code having an evaluation score higher than or equal to the threshold score exists in the database.

The computing apparatuses, the electronic devices, the processors, the memories, the displays, the information output system and hardware, the storage devices, and other apparatuses, devices, units, modules, and components described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A code provisioning device configured to provide code in a programming language, the code provisioning device comprising:
one or more processors; and
a memory storing instructions that when executed by the one or more processors, cause the code provisioning device to:
receive a code generation request comprising information on a target task through an interface of the code provisioning device,
in response to the receiving of the code generation request, obtain from a code generation model first code in the programming language and corresponding to the target task,
determine an evaluation score for the first code based on attempting to build the first code,
determine whether the evaluation score for the first code is higher than or equal to a threshold score, and
determine whether to add the first code to a database based on the evaluation score for the first code and based on an evaluation score for second code if the evaluation score for the first code is higher than or equal to the threshold score,
wherein the second code is related to the target task stored in the database.

2. The code provisioning device of claim 1, wherein the instructions, when executed by the one or more processors, cause the code provisioning device to
determine the evaluation score for the first code based on a result of evaluating performance regarding a result of the attempting to build the first code with respect to each of performance evaluation items to evaluate performance of code in the programming language and corresponding to the target task.

3. The code provisioning device of claim 1, wherein the instructions, when executed by the one or more processors, cause the code provisioning device to
determine to add the first code to the database based on the evaluation score for the first code being higher than or equal to a maximum value among evaluation scores for at least one item of second code stored in the database.

4. The code provisioning device of claim 1, wherein the instructions, when executed by the one or more processors, cause the code provisioning device to
determine to provide the second code as a response to the code generation request if the evaluation score for the first code is higher than or equal to the threshold score and the evaluation score for the first code is lower than the evaluation score for the second code.

5. The code provisioning device of claim 1, wherein the instructions, when executed by the one or more processors, cause the code provisioning device to
determine to add the first code to the database based on the evaluation score for the first code being lower than the threshold score and based on an item of code not existing in the database.

6. The code provisioning device of claim 1, wherein the instructions, when executed by the one or more processors, cause the code provisioning device to
determine to provide the second code as a response to the code generation request based on the evaluation score for the first code being lower than the threshold score and the second code having an evaluation score higher than or equal to the threshold score.

7. The code provisioning device of claim 1, wherein the instructions, when executed by the one or more processors, cause the code provisioning device to
determine to add the first code to the database, and
determine to provide the first code as a response to the code generation request.

8. The code provisioning device of claim 1, wherein the instructions, when executed by the one or more processors, cause the code provisioning device to
determine the evaluation score for the first code after determining to provide the first code obtained from the code generation model as a response to the code generation request.

9. The code provisioning device of claim 8, wherein the instructions, when executed by the one or more processors, cause the code provisioning device to
determine to delete the first code without storing the first code in the database based on the evaluation score for the first code being higher than or equal to the threshold score and based on the evaluation score for the first code being lower than the evaluation score for the second code.

10. The code provisioning device of claim 8, wherein the instructions, when executed by the one or more processors, cause the code provisioning device to
determine to discard the first code without storing the first code in the database based on the evaluation score for the first code being lower than the threshold score and based on the second code having an evaluation score higher than or equal to the threshold score.

11. A code provisioning method using a code provisioning device, the code provisioning method comprising:
receiving a code generation request comprising information on a target task through an interface of the code provisioning device;
in response to the receiving of the code generation request, obtaining from a code generation model first code written in the programming language and corresponding to the target task;
determining an evaluation score for the first code based on attempting to build the first code;
determining whether the evaluation score for the first code is higher than or equal to a threshold score; and
determining whether to add the first code to a database based on the evaluation score for the first code and based on an evaluation score for second code if the evaluation score for the first code is higher than or equal to the threshold score,
wherein the second code is related to the target task stored in the database.

12. The code provisioning method of claim 11, wherein the determining of the evaluation score comprises:
determining the evaluation score for the first code based on a result of evaluating performance regarding a result of the attempting to build the first code with respect to each of performance evaluation items to evaluate performance of code in the programming language and corresponding to the target task.

13. The code provisioning method of claim 11, wherein the determining of whether to add the first code to the database comprises:
determining to add the first code to the database based on the evaluation score for the first code being higher than or equal to a maximum value among evaluation scores for at least one item of second code stored in the database.

14. The code provisioning method of claim 11, wherein the determining of whether to add the first code to the database comprises:
determining to provide the second code as a response to the code generation request based on the evaluation score for the first code being higher than or equal to the threshold score and the evaluation score for the first code being lower than the evaluation score for the second code.

15. The code provisioning method of claim 11, further comprising:
determining to add the first code to the database based on the evaluation score for the first code being lower than the threshold score and based on an item of second code not existing in the database.

16. The code provisioning method of claim 11, further comprising:
determining to provide the second code as a response to the code generation request based on the evaluation score for the first code being lower than the threshold score and the second code having an evaluation score higher than or equal to the threshold score existing in the database.

17. The code provisioning method of claim 11, further comprising:
adding the first code to the database; and
determining to provide the first code as a response to the code generation request.

18. The code provisioning method of claim 11, wherein the determining of the evaluation score for the first code comprises:
performing the determining of the evaluation score for the first code after determining to provide the first code obtained from the code generation model as a response to the code generation request.

19. The code provisioning method of claim 18, further comprising:
determining to discard the first code without storing the first code in the database based on the evaluation score for the first code being higher than or equal to the threshold score and the evaluation score for the first code is lower than the evaluation score for the second code.

20. A method performed by a computing device, the method comprising:
accessing a database of stored items of second code respectively corresponding code-generation requests;
inputting the code-generation requests to a code generation model comprising a neural network to generate respective items of first code;
determining scores of the respective items of first code;
for first of the items of first code, storing in the database the first items of first code based on their having scores above a threshold and there being no corresponding item of second code and returning the first items of first code as responses to the corresponding code-generation requests; and
for second of the items of first code, based on the second items of first code having scores above the threshold and having respectively corresponding items of second code with higher scores, returning as responses to the corresponding code-generation requests respectively corresponding items of second code.
